(19) United States
(12) Patent Application Publication
(10) Pub. No.: US 2014/0359593 A1
(43) Pub. Date: Dec. 4, 2014

(54) MAINTAINING KNOWN DEPENDENCIES FOR UPDATES

(71) Applicant: Microsoft Corporation, Redmond, WA (US)

(72) Inventors: Jordan Cohen, Redmond, WA (US); Mark Henriksen Phaedrus, Kenmore, WA (US); Michael Ratanapintha, Redmond, WA (US); Faisal Ansari, Redmond, WA (US); Rajiv Poonamalli, Redmond, WA (US); Rajasekaran Rangarajan, Redmond, WA (US); James Cavalaris, Redmond, WA (US); David J. Roth, Redmond, WA (US); Ullattil Shaji, Redmond, WA (US); Karl Hessler, Redmond, WA (US); Katy Kneale, Redmond, WA (US)

(21) Appl. No.: 13/907,570

(22) Filed: May 31, 2013

(51) Int. Cl. G06F 9/445

(52) U.S. Cl. CPC G06F 8/65
USPC 717/169

(57) ABSTRACT

A computer-implemented method for maintaining update dependencies includes receiving, at a computing device, an update set from an update service. The update set may include a dependent set including a first update having a dependency on a second update in the update set. The first and second updates are separated from the update set and installed. Upon installation, an activation condition may be applied to the first and second updates.

### BACKGROUND

Computing devices typically include various functionalities that may be updated from time to time. For example, a component device of a computing device (e.g., a graphics card, a data storage device, an input device, and so forth) may be associated with a device driver that enables the component device to function in the context of the computing device. A manufacturer or other entity associated with the component device may issue an update to the device driver, such as to fix a software bug, solve a compatibility issue, enhance functionality of the component device, and so on. The update may be installed on the computing device to replace or augment a previous version of the device driver.

Similarly, a software application installed on a computing device may be updated. For example, an operating system developer may issue an update to the operating system, such as to fix a security vulnerability, fix a bug, and so forth. Determining which updates to install on a computing device, and how to install the updates, involves a number of considerations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Presented herein are techniques for maintaining known dependencies for updates within an update set. According to these techniques, updates may be retrieved for various functionalities, such as operating systems, applications, services, drivers, and so forth. In at least some implementations, techniques enable relationships between two or more updates in an update set to be maintained in a variety of ways. For example, an update may be designated as including a dependency on at least one other update. An update dependency designation may be applied to updates that are grouped together within an update set for one or more reasons. In at least some implementations, dependency rules for dependent sets may be generated and/or applied to group a dependent set of updates within an update set after the individual updates have been published and/or propagated to a target computing device.

Updates that are included in a dependent set may be associated with dependency rules that specify that two or more updates are to be installed together. In at least some implementations, update set rules and dependency rules for updates may be dynamically created, configured, and/or dynamically reconfigured.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario in accordance with one or more embodiments.

FIG. 3 is a flow diagram that describes operations in a method in accordance with one or more embodiments.

FIG. 4 is a flow diagram that describes operations in a method in accordance with one or more embodiments.

FIG. 5 is a flow diagram that describes operations in a method in accordance with one or more embodiments.

FIG. 6 is a flow diagram that describes operations in a method in accordance with one or more embodiments.

FIG. 7 is a flow diagram that describes operations in a method in accordance with one or more embodiments.

FIG. 8 is a flow diagram that describes operations in a method in accordance with one or more embodiments.

FIG. 9 is a flow diagram that describes operations in a method in accordance with one or more embodiments.

FIG. 10 is a flow diagram that describes operations in a method in accordance with one or more embodiments.

FIG. 11 is a block diagram illustrating example physical components of a computing device with which embodiments of the invention may be practiced.

FIGS. 12A and 12B are simplified block diagrams of a mobile computing device with which embodiments of the present invention may be practiced.

FIG. 13 is a simplified block diagram of a distributed computing system in which embodiments of the present invention may be practiced.

### DETAILED DESCRIPTION

Embodiments of the present disclosure provide techniques for maintaining known update dependencies within an update set. As discussed herein, updates may be retrieved for various functionalities, such as operating systems, applications, services, drivers, and so forth. Updates may be grouped into update sets prior to transmission to a computing device. Update sets are described in detail in application Ser. No. 13/571,849, entitled Aggregation of Update Sets, and filed Aug. 10, 2012, which is incorporated herein by reference. In at least some implementations, techniques enable dependency relationships between two or more updates (referred to herein as a dependent set) within an update set to be maintained in a variety of ways. For example, a dependent set may be formed to provide installation of the updates in the dependent set on a computing device as an integrated set. Grouping updates in a dependent set may be based on update set rules that specify whether a particular update may be grouped in a dependent set, and conditions under which the particular update may be grouped in the dependent set. In at least some implementations, dependency rules for updates may be generated and/or applied to group a dependent set of updates within an update set before the individual updates propagated to a target computing device.

As discussed herein, updates may be managed for various component devices and operating system functionalities. Systems and methods of the present disclosure may incorporate a client/server infrastructure that provides the ability of an operating environment to detect, download, and install updates as a dependent set of a received update set. For instance, the operating environment may be configured to check one or more updates in an update set for dependencies prior to installation of the updates and to separate updates having dependencies from updates without dependencies. In some instances, an update set including one or more dependent updates may be available from an external source (e.g., manufacturer, publisher, update service, etc.) through a network connection.

In the following discussion, an example operating environment and example implementation scenarios are described that are operable to employ the techniques described herein. Example procedures involving techniques discussed herein are also described that may be employed in the example environment as well as in other environments. Particularly, while the present disclosure is described with reference to a client and server configuration, the systems and methods of the present disclosure may be applicable to communications between any two or more computing environments, and such communication should be considered within the scope of the present disclosure. In particular, the present disclosure may also be applicable to mobile and wireless devices where traditional driver delivery mechanisms to support new or updated drivers are cumbersome. The particular embodiments described herein are intended in all respects to be illustrative rather than restrictive. Alternative embodiments will become apparent to those skilled in the art to which the present disclosure pertains without departing from its scope. Accordingly, the example environments are not limited to performing the example procedures. Likewise, the example procedures are not limited to implementation in the example environment.

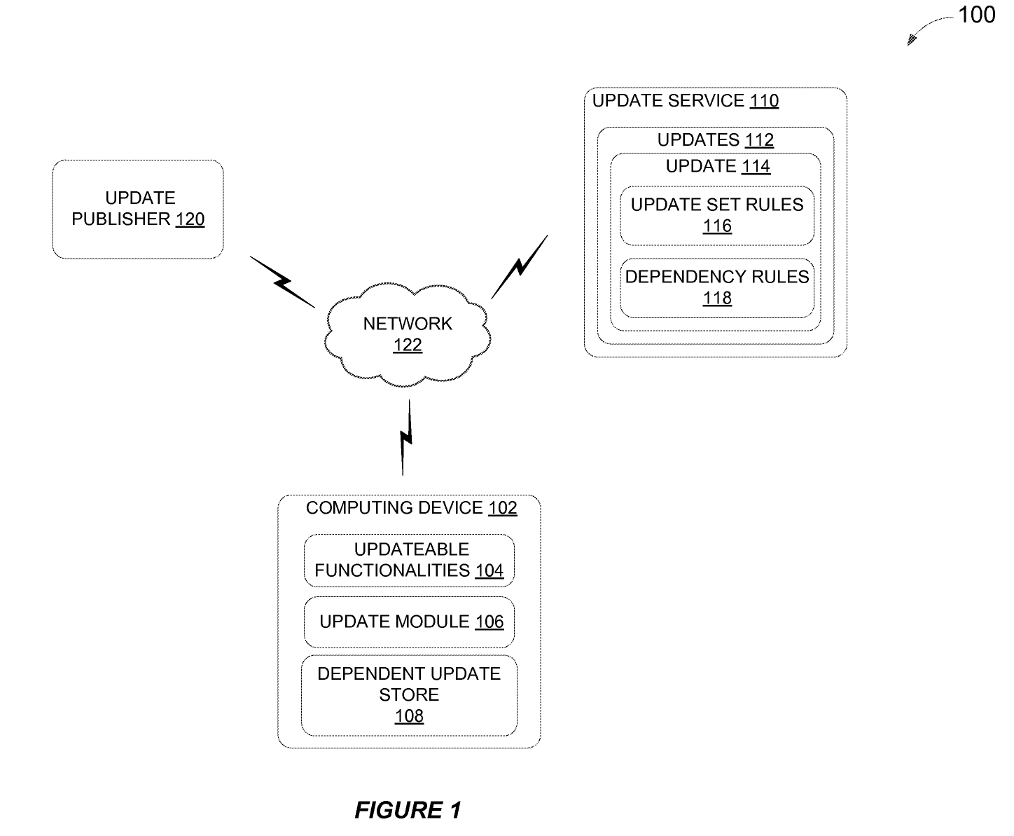

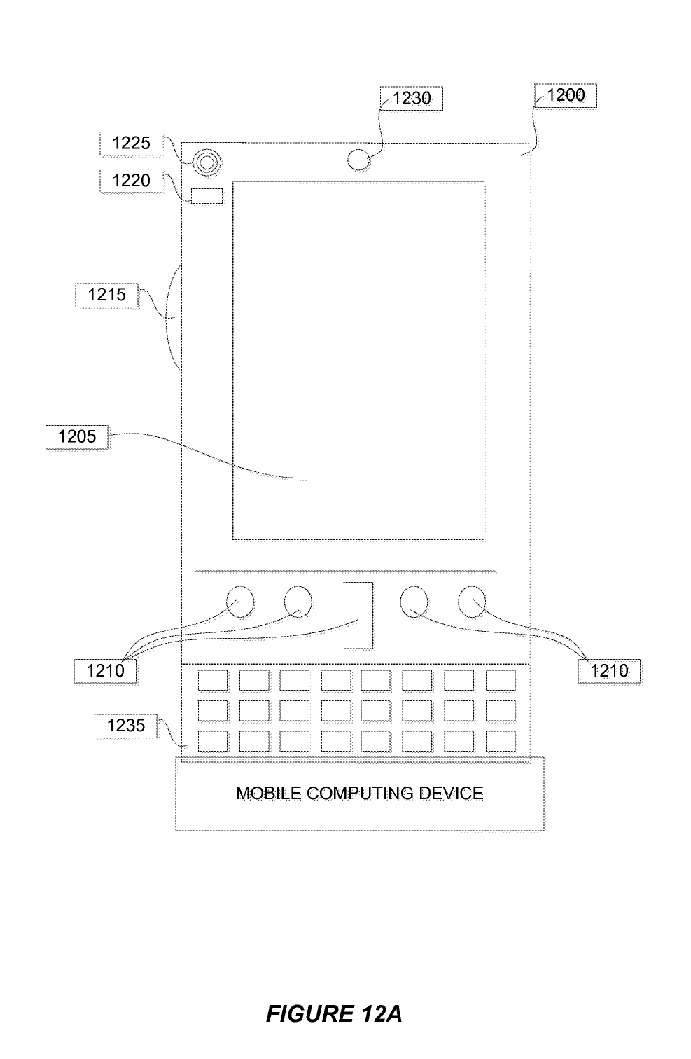

FIG. 1 is an illustration of an environment 100 in an example implementation that is operable to employ techniques for aggregation of update sets discussed herein. Environment 100 includes a computing device 102 which may be embodied as any suitable computing device such as, by way of example and not limitation, a desktop computer, a portable computer (e.g., a laptop), mobile phone, tablet computer, and so forth. One of a variety of different examples of a computing device 102 is shown and described below in FIG. 11.

Included as part of the computing device 102 are updateable functionalities 104, which are representative of functionalities that may be updated in various ways. Examples of the updateable functionalities 104 include an operating system, applications, services, device drivers, firmware, and so forth. Thus, updates may be installed on and/or associated with the computing device 102 to augment and/or replace various portions of the updateable functionalities 104.

An update module 106 is provided, which is representative of functionality to manage update operations for the computing device 102. For instance, the update module 106 may determine that an update is available for the updateable functionalities 104. The update module 106 may enable the update to be retrieved (e.g., downloaded from a network resource) and installed on the computing device 102. In some embodiments, a dependent update store 108 may be provided, which is discussed in greater detail below.

Further to embodiments, the computing device 102 is configured to communicate with an update service 110 via a network 122. The update service 110 is representative of functionality to manage updates for a variety of different computing devices (e.g., including the computing device 102), and to enable the updates to be provided to the computing devices. The update service 110 may be implemented as a network resource, such as via a web server. The network 122 may assume a wide variety of different configurations, such as the Internet, a wide area network (WAN), a local area network (LAN), a wireless network, a public telephone network, an intranet, and so on. Further, although a single network 122 is shown, the network 122 may be configured to include multiple networks. While various entities of the environment 100 are illustrated as communicating via the network 122, this is presented for purpose of example only. For instance, a wide variety of different communication channels other than the network 122 may be employed, such as to enable one group of entities to communicate via a different communication channel than another group.

The update service 110 includes updates 112, which may be representative of updates that may be distributed and/or made available to different computing devices. Generally, the updates 112 may include software, computer code, executables (e.g., a binary), and so on, that may be used to augment or replace existing code and/or functionality.

The updates 112 may include an example update 114, which in turn may include update set rules 116 and dependency rules 118. In at least some implementations, the update set rules 116 and/or dependency rules 118 may be specific to the update 114. Alternatively or additionally, at least some of the update set rules 116 and/or dependency rules 118 may be utilized for others of the updates 112. For example, one or more of the update set rules 116 and/or dependency rules 118 may be globally applied to the updates 112.

According to various embodiments, the update set rules 116 may specify whether a particular update 112 may be included as part of a set of updates. If a particular update 112 may be included in a set, the update set rules 116 may indicate various conditions that are to be met in order for the particular update 112 to be included in the set.

The dependency rules 118 may specify a relationship between a particular update 112 and at least one other update in an update set. For instance, the dependency rules 118 may specify an installation grouping (e.g., a dependent set) including a first update (e.g., update 112) and at least a second update of an update set. It is further contemplated that the dependency rules 118 may also specify dependencies on one or more other updates in an update set. Thus, updates that are included as part of a dependent set may be installed on the computing device 102 simultaneously, or substantially simultaneously, as a set and according to behaviors indicated in the dependency rules 118. As detailed elsewhere herein, the update set rules 116 and the dependency rules 118 may be modified, such as dynamically and/or “on-the-fly,” to affect various behaviors of the updates 112.

Further included as part of the environment 100 is an update publisher 120, which may be representative of entities that may publish and/or manage various types of updates. Examples of the update publisher 120 may include device manufacturers, such as a manufacturer of the computing device 102 and/or of component devices of the computing device 102. The update publisher 120 may also include software developers and/or other entities that may develop and/or issue updates for various components and functionalities. For instance, the update publisher 120 may include manufacturers and/or other entities associated with the updateable functionalities 104. Other examples of the update publisher 120 may include corporate administrators, contracted administrators, and other entities that are given the authority to specify and/or modify update-related behaviors, such as the update set rules 116 and/or the dependency rules 118. Thus, the update publisher 120 may publish and/or issue updates for the updateable functionalities 104, such as via the updates 112 managed by the update service 110. Alternatively or additionally, the update publisher may modify update-related behaviors, such as via modification of the update set rules 116 and/or the dependency rules 118.

The update publisher 120 may also specify and/or publish the update set rules 116 and/or the dependency rules 118. According to techniques discussed herein, the update publisher 120 and/or other entities may dynamically alter the update set rules 116 and/or the dependency rules 118. For example, the update publisher 120 may alter the update set rules 116 and/or the dependency rules 118 after the updates 112 have been published and/or distributed, such as to the update service 110 and/or the computing device 102.

Alternative components (not shown) may include a user interface configured to engage a user in the selection and decision to download or install updates. An example of such a service may be a Graphical User Interface (GUI) utility program that enables a user to select a particular update file for installation. Such a utility may be implemented with the systems and methods of the present disclosure to provide information about the computing device to a server that may then match and identify and appropriate updates.

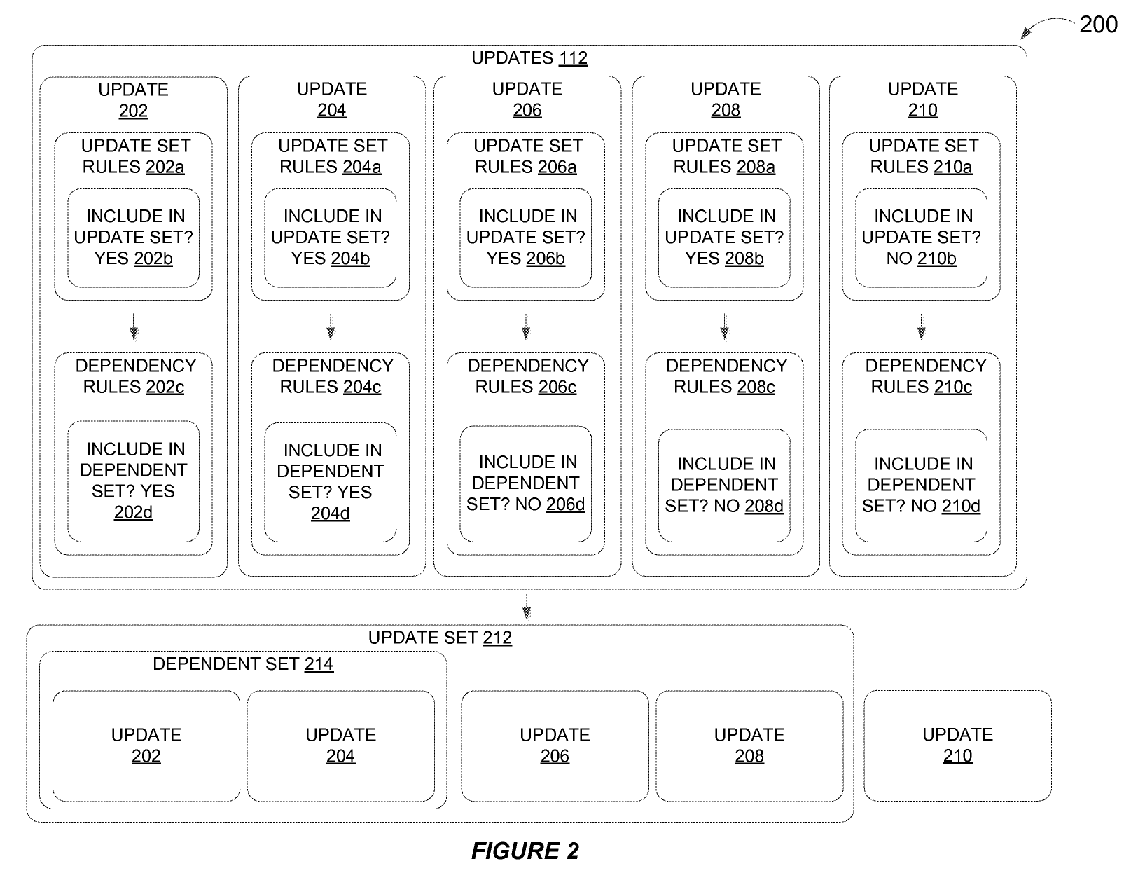

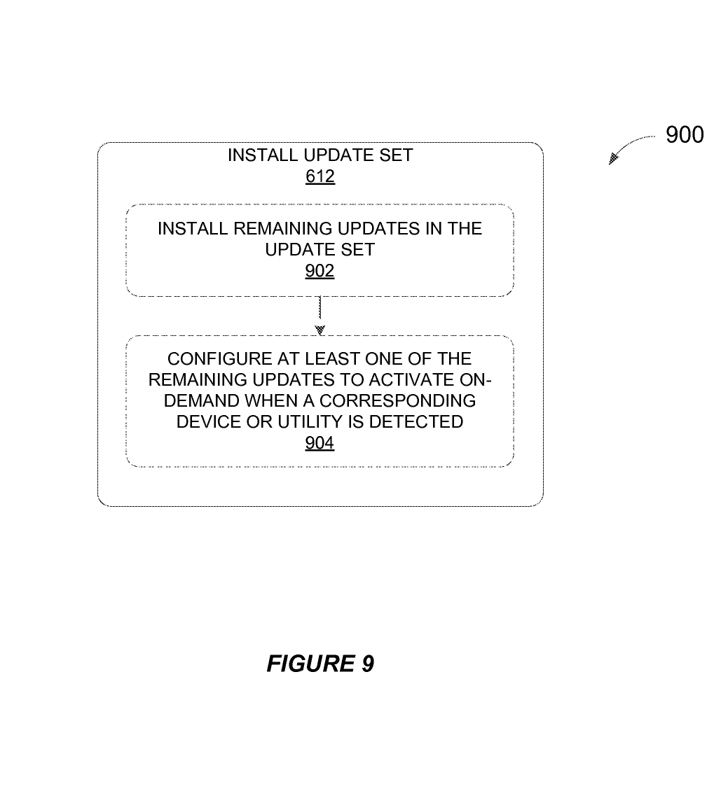

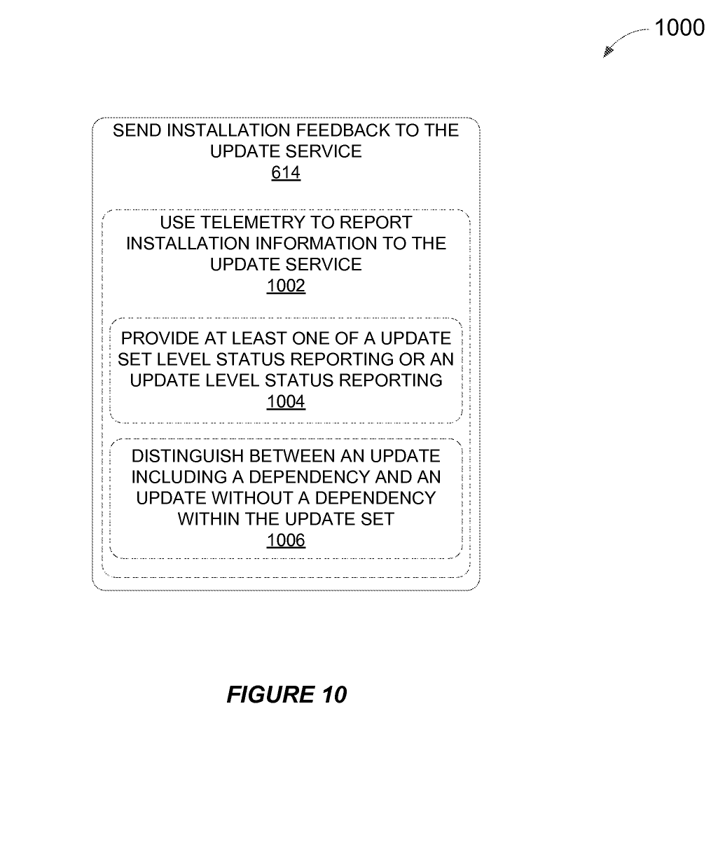

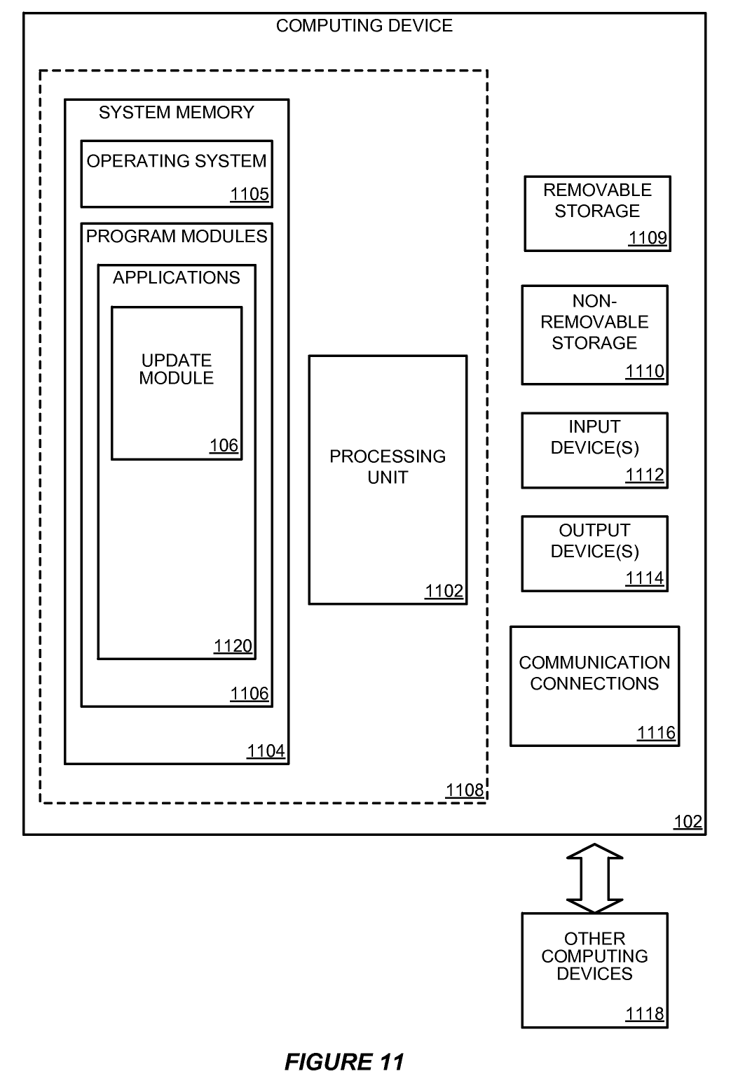

The following discussion describes example procedures for installing and updating device drivers in accordance with one or more embodiments of the present disclosure. In portions of the following discussion, reference will be made to the environment 100 of FIG. 1. In at least some embodiments, aspects of the procedures may be implemented via one or more of the entities discussed above, such as computing device 102 (or one of the computing device components discussed above), the update service 110 and/or the update publisher 120). However, references to specific components of FIG. 1 are for illustrative purposes only, and do not limit the disclosure to the embodiments described herein. The processes described below are further illustrated in FIGS. 2-10, where aspects of the example embodiments are depicted in flow diagrams that describe operations in one or more processes in accordance with one or more embodiments.

FIG. 2 illustrates an example implementation scenario utilizing various aspects of the environment 100, generally at 200. Illustrated in the scenario 200 are the updates 112, which include a number of example updates and associated update set rules for the respective updates.

Further to the scenario 200, consider updates 202-210, which include update set rules 202a-210a. Updates 202-210 may specify whether a particular update may be included as part of an update set, and conditions that may cause a particular update to be included or excluded from a set. In at least some implementations, the update set rules may be enforced and/or applied by various entities, such as the update module 106 of the computing device 102, the update service 110, and so on.

The update set rules 202a-210a may include rules 202b-210b, which may indicate whether the updates 202-210 are permitted to be included as part of a set of updates. The rules 202b-210b, for instance, may be implemented as a flag, such as “may be included in a set” or “not to be included in a set.” Thus, upon applying the update set rules 202b-210b, the update service 110 may evaluate one or more conditions under which the updates 202-210 may be included as part of an update set. As can be seen in FIG. 2, updates 202-208 may be included in the update set 212, and update 210 may be excluded. As indicated above, details regarding aggregating update sets in this manner are further described in in the aforementioned application entitled Aggregation of Update Sets.

Updates 202-210 may further specify whether a particular update is included as part of a dependent set, and conditions that may cause a particular update to be included or excluded from a dependent set. Thus, the scenario 200 further provides that updates in an update set 212 may be further designated as having one or more dependencies on another update in the update set 212. To this end, the updates 202-210 may include dependency rules 202c-210c. In at least some implementations, dependency rules 202c-210c may be enforced and/or applied by various entities, such as the update module 106 of the computing device 102, the update service 110, and so on. Dependency rules may be based on dependency information received from an external source (e.g., update publisher 120). Dependency rules 202c-210c may include rules 202d-210d which may indicate, based on dependency information for an update, that one or more of the updates 202-210 are to be included as part of a dependent set (or update subset). The rules 202d-210d, for instance, may be implemented as a flag, such as “to be included in a dependent set” or “not to be included in a dependent set.” Thus, upon applying the update set rules 202b-210b, the update service 110 may evaluate one or more conditions under which the updates 202-210 may be included as part of a dependent set.

To this end, one or more rules 202d-210d may be applied to the updates 202-210. The conditions that may give rise to an update dependency may include, for instance, device attributes (e.g., for the computing device 102) that may cause an update to be included or excluded from a dependent set of an update set. Examples of such device attributes include identifying attributes of a computing device, such as a manufacturer (e.g., an original equipment manufacturer (OEM,)) for the computing device, a make for the computing device (e.g., the brand), a particular model of the computing device (e.g., a model number), and so forth. For example, a particular manufacturer may have multiple makes (e.g., brands) of computing devices. Further, a particular make of computing device may encompass multiple different models.

Such device attributes may also include a variety of other information, such as identifiers for component devices, a data storage device, input/output devices, processors, and so on. Device attributes may also include identifiers for software and/or firmware installed on the computing device 102, including identifiers for the operating system and the currently installed version thereof. Attributes specified by the dependency rules 202c-210c may also specify different state conditions, such as device driver versions that are installed on a device, application versions that are installed on a device, available memory, and so on.

Referring specifically to update 202, the update 202 may further include corresponding dependency rules 202c. The dependency rules 202c may identify other updates (e.g., update 204) on which the update 202 may have a dependency. The update 202 then may be designated as having a dependency on update 204. The dependent set rule 202d may further specify that if the particular update (e.g., update 204) is included in the update set 212, the update 202 is to be grouped with update 204 in a dependent set 214. Additionally or alternatively, the dependency rules 202c may specify that the update 202 does not include a dependency on another update, and thus will not be grouped with another update or group of updates in a dependent set (unless a different update is indicated as having a dependency on update 202).

In this particular example, the conditions specified by the dependency rules 202c are satisfied, and thus the update 202 may be included as part of a dependent set 214. Thus, the updates 202 and 204 may be provided to the computing device as a dependent set. The update service may also provide an indication to the computing device 102 that, based on applied dependency rules 202c, the update 202 has a dependency on the update 204 and that the two updates are to be installed together as dependent set 214.

The other updates include their own particular dependency rules. For instance, an update 204 includes dependency rules 204c. The dependency rules 204c may be applied to the update 204 and may specify that update 204 has a dependency on update 202. Rule 204d may further specify, based on the dependency indication of update 202, that the update 204 is to be included as part of a dependent set (e.g., with update 202). The updates 202 and 204 may then be provided to one or more computing devices as a dependent set 214. Specifically, the dependency designations for updates 202 and 204 may passed to the computing device 102 to enable computing device 102 to process and install updates 202 and 204 together as a dependent set 214 of the update set 212.

Similarly, updates 206-210 include dependency rules 206c-210c, respectively. The dependency rules 206c-210c may include rules 206d-210d which may be applied, and an indication that the updates 206-210 do not have a known dependency on another update in the update set 212 may be provided. Thus, the updates 206-210 may be excluded from the dependent set 214, and may be provided as part of the update set 212 without any further dependency designations.

In some embodiments, the update 210 may be excluded from the dependent set 214 by default based on the determination that the update 210 is not a member of the update set 212. In this particular example, an evaluation of both the update set rules 210a and the dependency rules 210c may indicate that conditions are such that the update 210 may not be included as part of the update set 212 (and therefore may also be excluded from the dependent set 214). Thus, the update 210 may be presented as an individual update, or may be withheld from presentation as an available update.

Based at least in part on the update set rules for the respective updates of the update set 212, and the dependency rules for the dependent set 214, the updates may be configured for transmission to the computing device 102. In some embodiments, the update service 110 may designate install conditions for installation of the updates of both the update set 212 and the dependent set 214. The install conditions may include a variety of install parameters for the installation of the dependent set 214. For instance, the install rules may specify that if installation of any of the updates within the dependent set 214 fails, installation of the entire dependent set may be rolled back and/or postponed until a designated time, or after a reboot. The install rules may also include presentation parameters for the dependent set 214, such as a display name for the dependent set 214 and/or other graphical features for presentation of the dependent set 214.

The dependency rules referenced above may be generated by a variety of different entities, such as the update publisher 120, the update service 110, and/or the update module 106. The dependency rules may also be maintained in a variety of different ways and/or locations, such as part of their respective updates, as files separate from the updates stored by a resource such as the update service 110 and/or the computing device 102, and so forth. For example, metadata within a particular update may reference a remote location where dependency rules may be retrieved for the update. This may enable an entity to make changes to the rules without having to access an actual instance of the update at a particular device. In at least one embodiment, the dependency rules may be generated and maintained by the update service 110. Further, modifications to the dependency rules may be made via the update service 110, such as after respective updates have been published to the update service 110 and/or the computing device 102.

While a single dependent set 214 is illustrated, it is to be appreciated that techniques discussed herein may be employed to create multiple different dependent sets, and to create relationships between different dependent sets. For example, based on particular update set rules and/or dependency rules, updates may be grouped into different update sets and/or dependent sets. Conflicting update interaction rules for a particular set of updates, for instance, may cause an update set to be separated into two or more different update sets that may be grouped together based on compatible interaction rules. Each update set may in turn include one or more dependent sets having one or more known dependencies.

Having described an example environment and example implementation scenarios in which the techniques described herein may operate, a discussion is now provided of some example procedures in accordance with one or more embodiments.

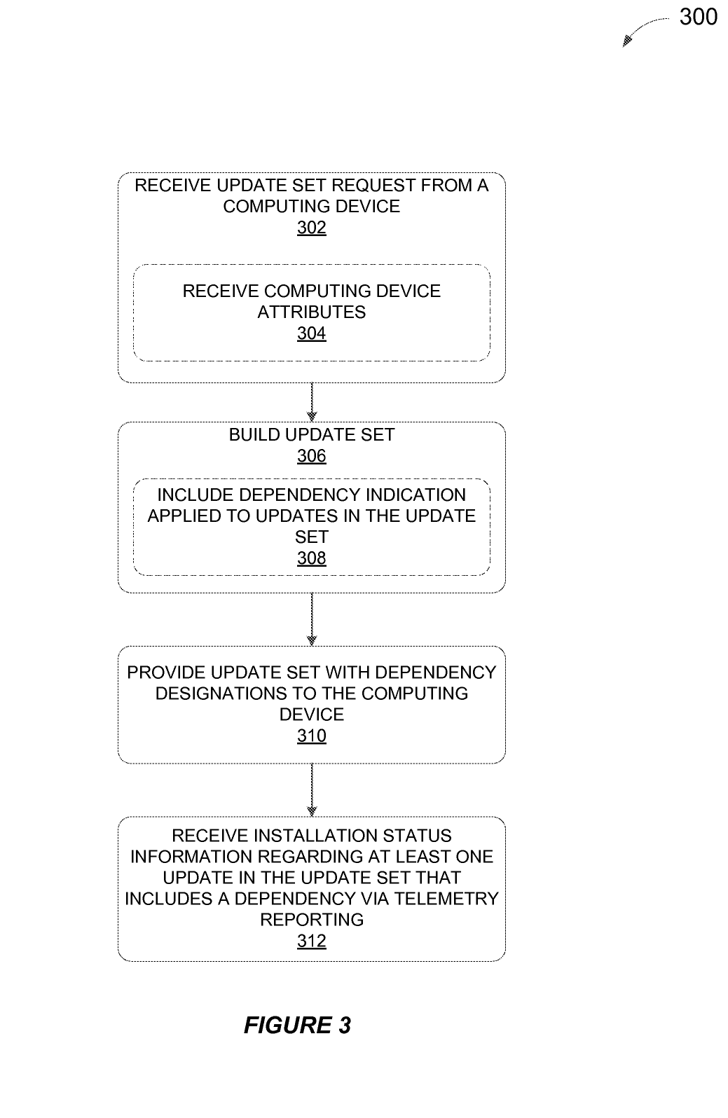

The following discussion describes example procedures for maintaining update dependencies within update sets in accordance with one or more embodiments. In portions of the following discussion, reference will be made to the environment 100 of FIG. 1, and the implementation scenario 200 FIG. 2. In at least some embodiments, aspects of the procedures may be implemented via entities discussed above, such as the update module 106 and/or the update service 110. It should be noted that the update module 106, the update service 110, and/or the update publisher 120 are examples of any number of utilities that may be configured to perform one or more operations of the below methods. References to specific components of FIGS. 1 and 2 are for illustrative purposes only, and do not limit the disclosure to the embodiments described herein. The processes described below are further illustrated in FIGS. 3-10, where aspects of the example embodiments are depicted in flow diagrams that describe operations in one or more processes in accordance with one or more embodiments.

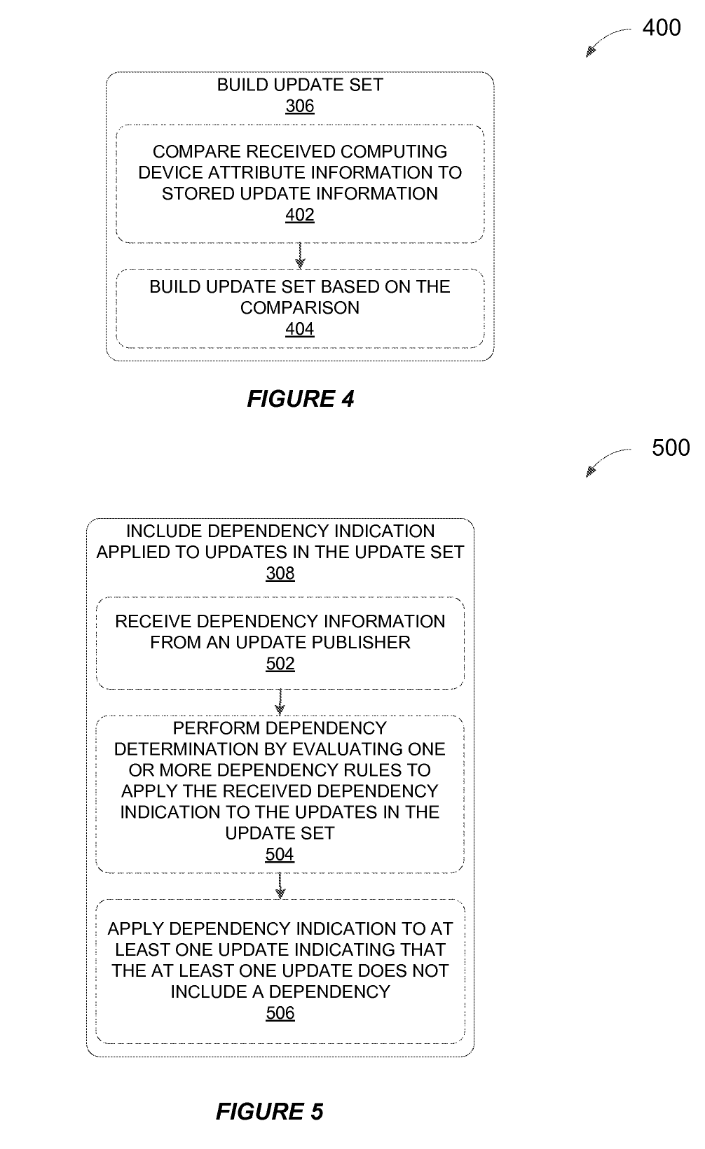

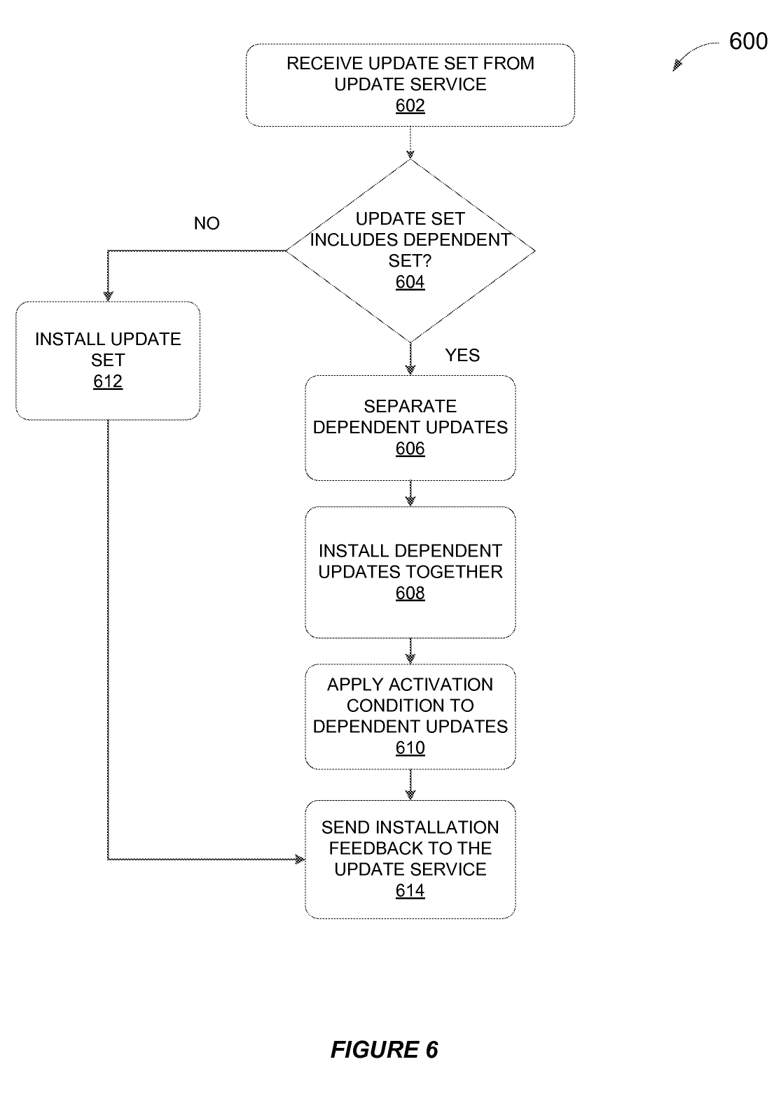

An example embodiment is depicted in FIG. 3, where a method 300 for maintaining known dependencies within update sets is illustrated. Additional embodiments are depicted in FIGS. 4 and 5, where methods 400 and 500 provide additional and/or optional process operations relating to method 300.

Method 300 may begin at operation 302, where a request for an update set is received. For instance, the computing device 102 (e.g., via the update module 106) may query the update service 110 for updates for the updateable functionalities 104. Operation 302 may alternatively include operation 304, where one or more computing device attributes may be received when the request is received. In at least some implementations, the query may include various computing device attributes including hardware configuration information and/or computing device state information that may enable updates to be located, such as identifiers for the updateable functionalities 104, device state information, and so on. In further embodiments, the request may not be necessary (e.g., if an update service is configured to push updates out to computing devices without requests) or the request may be made in response to a reminder sent by the update service to the computing device.

Method 300 may proceed to operation 306, where an update set is built for a computing device. For instance, the updates may be gathered into an update set and provided in response to a query by the computing device 102 (e.g., via the update module 106) to the update service 110 for updates for the updateable functionalities 104. Alternatively or additionally, the updates may be gathered by the update service 110 and pushed to the computing device 102 independent of a query from the computing device 102. In some embodiments, operation 306 may alternatively include operations 402 and 406 of FIG. 4. At operation 402, building an update set may further include comparing the received computing device attribute information (e.g., hardware and state information) to update information stored on the update service. For instance, the update service 110 may select updates for the update set according to stored available updates appropriate for the requesting computing device. At operation 404, the update set may be built based on the comparison.

Operation 306 may also alternatively include operation 308, where a dependency indication is applied to one or more updates in the update set. In some embodiments, the update service 110 may evaluate whether one or more updates in the update set includes a dependency on one or more other updates in the update set. Specifically, the update service 110 may set one or more deployment attributes including, for instance, known dependencies, for each update in an update set. In some embodiments, operation 308 may alternatively include operations 502, 504, and 506 of FIG. 5. At operation 502, dependency information may be received from an update publisher. At operation 504, a dependency evaluation may be performed by evaluating one or more dependency rules to apply the received dependency information to the updates in the update set. For example, the update service 110 may determine based on the dependency rules 118 for the respective update set, whether individual updates may be further grouped into a dependent set for grouped installation on the computing device 102. As discussed above, the dependency rules may include an explicit indication that particular updates in an update set are to be included as part of a dependent set. The dependency rules may also specify certain conditions under which particular updates may or may not be included as part of a dependent set, such as based on device attributes, a computing device configuration, other updates with which a particular update may or may not be grouped in a dependent set, and so forth. In at least some implementations, ascertaining whether updates within an update set include dependencies may occur after the updates have been individually published and distributed, such as after the updates 112 have been provided from the update publisher 120 to the update service 110 and/or the computing device 102. For example, the update service 110 may evaluate the dependency rules 118 after the initiation of an update process to ascertain whether the updates 112, having already been grouped in an update set, may be further grouped in a dependent set. Thus, whether or not a particular update is grouped in a dependent set may depend on dynamic device state conditions that may change after the update is published by one of the update service or the update publisher 120. In some embodiments, method 500 may alternatively include operation 506, where a dependency indication that the update does not include any dependencies may be applied to at least one update.

In some embodiments, an update set may be published to the update service 110. For instance, the update set may be received from the update publisher 120. In such embodiments, individual updates within that set may be pre-marked as either having one or more dependencies or not having one or more dependencies. Each update having a dependency relationship (e.g., either dependent on or depended on) with another update may be grouped together.

When the updates have received their respective dependency indications, method may proceed to operation 310, where the update set is provided to the computing device. For example, the update set 212 may be provided to a device (e.g., the computing device 102) for installation as a set. The update service may also be configured to communicate dependency information to the computing device 102 (e.g., via the update module 106 or a hardware manager). For instance, the update service 110 may communicate to the computing device that, within the update set 212, a dependent set 214 is present. Dependent set 214 may be designated as such for further processing by the computing device 102 prior to installation. In at least some embodiments, a notification may be presented that the dependent set of updates are to be installed. In some embodiments, the update service 110 provides an indication to the computing device that updates in the dependent set are to be installed as a single entity. For instance, when updates are grouped into a dependent set for installation, a user may be prevented from initiating installation of individual updates of the dependent set without allowing installation of the entire dependent set. Further, if installation of a dependent set is started and interrupted without all updates having been installed, the installed updates of the partially installed dependent set may be rolled back to pre-installation states. Thus, in at least some implementations, updates in a dependent set may be installed as a set, or not at all. By enforcing an “all or nothing” installation policy, mixed update states among dependent drivers may be avoided.

After one or more updates have been installed on the computing device, method 300 may alternatively proceed to operation 312, where installation feedback is received by the update service. In some embodiments, the feedback is received in the form of telemetry reporting, as will be discussed in further detail below.

Various update-related behaviors may be dynamically modified, such as after a particular update has been published and propagated to a target device. This may enable various entities, such as the update service 110 and/or the update publisher 120, to respond to a variety of dynamically changing conditions in determining whether to group particular updates in a set, and in specifying interaction behaviors and dependencies between updates. In such embodiments, an update set may not require republication if an individual update is altered or a dependency is changed. Rather, by modifying an element of the update set definition, changes to update sets and dependencies may be effected without republication.

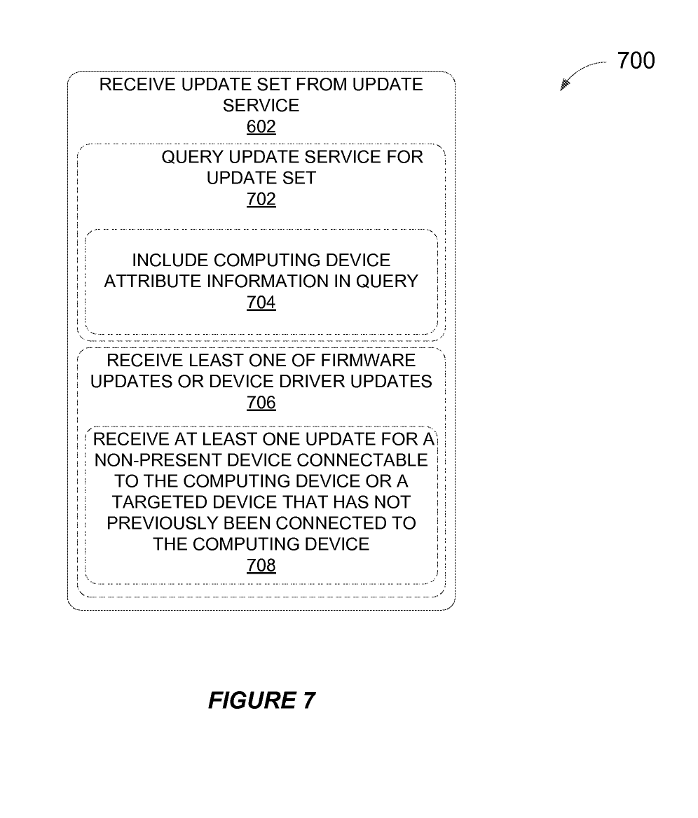

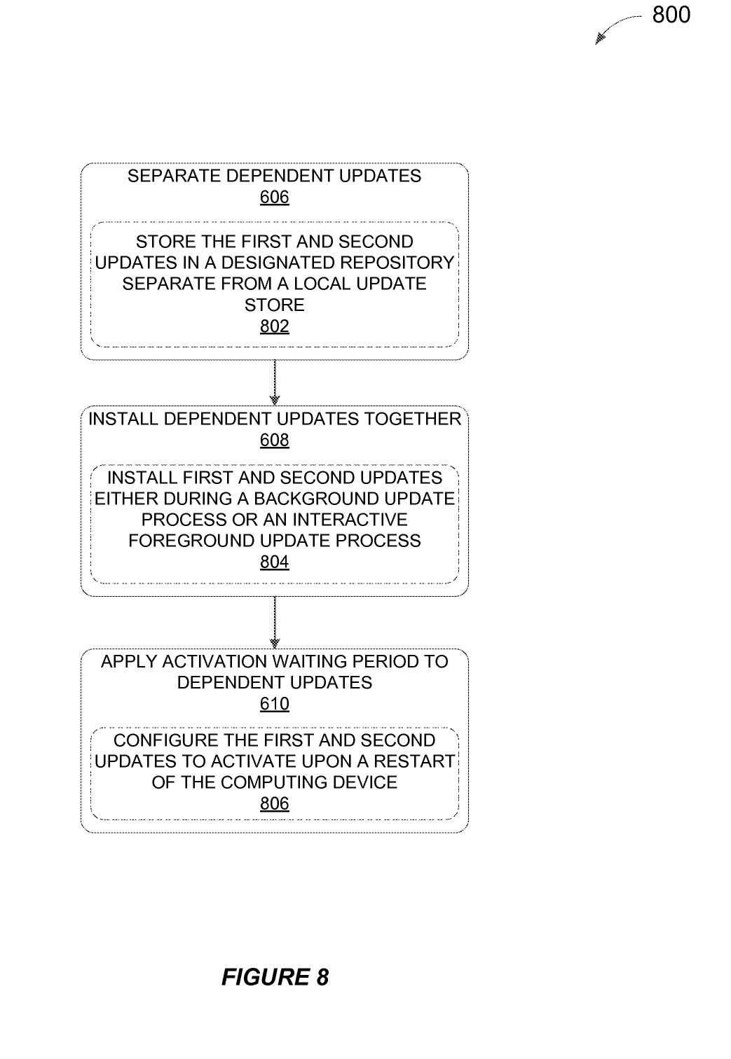

What follows is a discussion of one or more processes executable on the computing device 102 to maintain update set dependencies during update installations. FIG. 6 is a flow diagram that describes operations in a method in accordance with one or more embodiments. Additional embodiments are depicted in FIGS. 7-10, where methods 700, 800, 900, and 1000 provide additional and/or optional process operations relating to method 600.

Method 600 may begin at operation 602, where an update set is received from an update service. In some embodiments, operation 602 may alternatively include operations 702-708 of FIG. 7. For instance, the update set may be received in response to a query 702 (e.g., by the update module 106) to the update service 110 for an update set relating to one or more for the updateable functionalities 104. A query for updates may be initiated by a user, a scheduled task, or other appropriate process executable in the operating environment of the computing device. The computing device 102 (e.g., via the update module 106) may be configured to request a most current update set from the update service. Such requests may be performed on-demand, such as during the initial first run of a brand new device, when the computing device 102 detects an available connection to the update service, or at scheduled intervals.

In some embodiments, computing device attribute information may also be included 704 in the query to the update service 110 during an update check. Computing device attribute information may include hardware configuration information and operating environment characteristics. Operating environment characteristics may include information such as a description of the operating system, spoken language, BIOS information, stat information, etc. In at least some implementations, the query may also include various device attributes that may enable updates to be located, such as identifiers for the updateable functionalities 104, device state information, and so on. Examples of device attributes are discussed above. An update set may be received (e.g., detected and downloaded) by the computing device 102 based on the configuration and operating environment state information and/or the device information. Alternatively or additionally, an update set may be received by the computing device 102, e.g., independent of a query from the computing device 102 (e.g., pushed from the update service 110). In some embodiments, receiving the update set may include receiving 706 at least one of a set of firmware updates or device driver updates. In instances where the received update set is a set of device driver updates, method 700 may further include receiving 708 at least one update for a non-present device connectable to the computing device or a targeted device that has not previously been connected to the computing device. Further details of non-present and targeted devices are provided in Driver Installation for Targeted and Non-Present Devices, application Ser. No. 13/907,069, filed May 31, 2013, which is incorporated by reference herein in its entirety.

When the update set is received by the computing device, method 600 may proceed to operation 604, where one or more updates in the update set are evaluated to determine whether an update includes a dependency on one or more other updates in the update set. For example, the update module 106 may determine, based on received dependency information for each update, whether individual updates are further grouped into a dependent set and designated for installation as a set on the computing device 102. As discussed above, the dependency information may be derived from dependency rules that apply an explicit dependency indication to the updates in the received update set.

Upon receipt of the update set, the computing device 102 (e.g., via the update module 106) may be configured to recognize whether updates in a received update set include dependencies within the update set. For instance, updates within the update set may be scanned for a dependency indication. In at least some implementations, ascertaining whether updates within an update set include dependencies may occur after the updates have been provided from the update service 110 to the computing device 102. For example, the update module 106 may evaluate the dependency rules 118 after the initiation of an update process to ascertain whether the updates 112, having already been grouped in an update set, may be further grouped in a dependent set. Thus, whether or not a particular update is grouped in a dependent set may depend on dynamic device state conditions that may change after the update is published by one of the update service 110 and/or the update publisher 120.

If the dependency evaluation indicates that one or more updates of the update set are designated as members of a dependent set (“Yes”), operation 606 may separate the updates belonging to the dependent set from the remaining updates in the update set. Specifically, an update in the update set having a dependency on another update in the update set, as well as the update upon which the first update depends, may be separated from the remaining updates in the update set. In some embodiments, operation 606 may further include operation 802, where the dependent set updates are stored in a designated repository separate from a local update store. For example, updates may be grouped in a dependent set, such as by the update module 106 and/or the update service 110, and sent to a designated location (e.g., dependent update store 108) prior to installation on the computing device 102. In at least some embodiments, a notification may be presented that the dependent set of updates are to be installed together. A dependent set location may also be provided in the notification.

In some embodiments, the separated dependent set of updates may be passed to a separate repository (e.g., dependent store 108) while the remaining updates in the update set are passed to a general driver store for installation. Passing the dependent set to a separate repository may ensure that the updates in the dependent set are installed together. The computing device 102 may be further configured to maintain the dependencies when the update set is detected and downloaded (e.g., received from the update service) as well as when the update is installed. To this end, the update module 106 may receive an indication that one or more updates are in the dependent update store 108 are separate from any other updates or drivers that are detected, downloaded, and installed.

Upon separating the dependent set (e.g., the updates including dependencies) from the remaining updates in the update set, method 600 may proceed to operation 608, where the updates in the dependent set may be installed. If the dependent set updates are device driver updates, the update module 106 may manage the installation of the updates. In some embodiments, the dependent set may be passed to a general driver store (or other location where updates are installed). If the dependent set includes driver updates, the driver store may install the updates simultaneously, or substantially simultaneously. If the dependent updates are firmware updates, a program such as a unified extensible firmware interface (UEFI) may manage installation of the firmware updates. For instance, the firmware updates may be passed to the UEFI for installation. In some embodiments, operation 608 may further include operation 804, where the updates are installed either during automatic background updating or interactive foreground updating. During initial installation of the dependent set, if any updates fail, the entire dependent set may be rolled back. Rolling back the dependent set (e.g., to a prior update set version) may prevent a mixed driver or firmware state (e.g., a combination of older and new driver and/or firmware updates).

After installation of the updates in the dependent set, operation 610 applies an activation condition to the updates in the dependent set. Upon installation, an activation condition (e.g., included with the update) may be applied to the dependent set updates. Operation 610 may be optional. Thus, in some embodiments, no further instructions are applied to the updates after installation, and any subsequent processing may be executed in a manner controlled by the computing device 102. In some embodiments, applying an activation condition to the updates may include instructing the update to activate upon installation. In other embodiments, applying an activation condition includes applying an activation waiting period to the updates in the dependent set. In some embodiments, applying a waiting period prior to activation may include specifying that each update in the update set may not activate until a system reboot. That is, the dependent set updates may not be activated until a designated activation event has occurred. In some instances, operation 610 may further include operation 806, where the activation event is a restart of the computing device. The reboot may be initiated by a user, by the update module 106, or by any other computing device component configured to initiate a reboot of the computing device. On a next operating system boot, the computing device (e.g., via a hardware manager) may determine if a firmware installation is successful. For instance, during the next system reboot, execution of any pending firmware updates may be attempted. If the update succeeds, the computing device may activate the updates in the update set. If any firmware updates fail, then at the next operating system load, updates included in a previous update set version may be activated instead of the more recently installed updates, such that any expected dependencies are preserved in the event of an update installation failure. If all firmware updates succeed, or no firmware updates were pending, then the newly installed dependent updates from the update set may be activated. If activation is successful, each update in the set may be accessible by the computing device or a corresponding component device. In some embodiments, one or more updates for a device driver may be installed prior to a computing device reboot. In such embodiments, the computing device may be configured to enable firmware updates to finish prior to activation of device driver updates, to avoid mixed states between device driver versions and/or firmware versions.

If the updates are not members of a dependent set (“No”), method 600 may proceed to operation 612, where the updates in the update set may be evaluated according to previously discussed rules for evaluating update sets (e.g., according to update set rules and/or individually). In some instances, operation 612 may further include operation 902, where the remaining updates in the update set are installed. For example, the updates 112 may be evaluated individually or as part of the update set 212 to determine whether or not each of the updates is to be installed on the computing device 102. Update sets and/or individual updates, for instance, may be presented to a user for installation approval, such as via a user interface that includes a user-selectable option for approving installation of an update or update set. Updates in the update set without any known dependencies may be activated at any time. In some instances, operation 612 may further include operation 904, where one or more remaining updates are configured to activate on-demand when a corresponding device or utility is detected. This feature provides for installation of drivers for non-present devices (devices that have previously been connected to the computing device but are disconnected at the time of update request, download and/or installation) and/or target devices (devices that have not previously been connected to the computing device) in an update to proceed safely according to specified installation rules without encountering mixed states of firmware and driver versions.

At any time during the installation and/or activation process, method 600 may proceed to operation 614, where installation feedback may be provided to the update service. The computing device 102 may be configured to monitor update installation success or failure. Monitoring of an update installation status may be performed at an update set level or at an individual update level. The computing device (e.g., via the update module 106) may report installation status information (e.g., success/failure) to the update service. In some instances, operation 614 may further include operation 1002, where telemetry is used to report installation information to the update service. In some instances, operation 1002 may further include operation 1004, where at least one of an update set level status reporting or an update level status reporting is provided. In some instances, operation 1002 may further include operation 1006, where the telemetry is configured to distinguish between an update in including a dependency and an update without a dependency within an update set. The computing device 102 may include a telemetry reporting element configured to distinguish between items with dependencies and items without dependencies at the update set level. After an update set has ultimately succeeded or failed to install, the update module 106 may be configured to report telemetry (e.g., to the update service or update publisher) at one or more levels of hierarchy to provide information that may be used to further monitor and diagnose dependent update installation successes and failures. Telemetry reporting may be correlated by one or more of levels of specificity. For instance, reporting may be correlated by update set version, dependent set version, and/or individual update information. With the installation status information, an update service manager may diagnose successes and failures from multiple different perspectives.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the environment 100.

Techniques for installing updates with known dependencies are described. Although embodiments are described in language specific to structural features and/or methodological acts, it is to be understood that the embodiments defined in the appended claims are not necessarily limited to the specific features or acts described above. Rather, the specific features and acts are disclosed as example forms of implementing the claimed embodiments.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 11-13 and the associated descriptions provide a discussion of a variety of operating environments in which embodiments of the invention may be practiced. However, the devices and systems illustrated and discussed with respect to FIG. 11-13 are for purposes of example and illustration and are not limiting of a vast number of computing device configurations that may be utilized for practicing embodiments of the invention, described herein.

FIG. 11 is a block diagram illustrating physical components (i.e., hardware) of a computing device 102 with which embodiments of the invention may be practiced. The computing device components described below may be suitable for the computing devices described above. In a basic configuration, the computing device 102 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the device module 106. The operating system 1105, for example, may be suitable for controlling the operation of the computing device 102. Furthermore, embodiments of the invention may be practiced in conjunction with a graphics library, other operating systems, or any other application program and is not limited to any particular application or system. This basic configuration is illustrated in FIG. 11 by those components within a dashed line 1108. The computing device 102 may have additional features or functionality. For example, the computing device 102 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., the device module 106) may perform processes including, but not limited to, one or more of the stages of the method 200 illustrated in FIG. 2. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the device module 106 may be operated via application-specific logic integrated with other components of the computing device 102 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 102 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 102 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 102. Any such computer storage media may be part of the computing device 102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

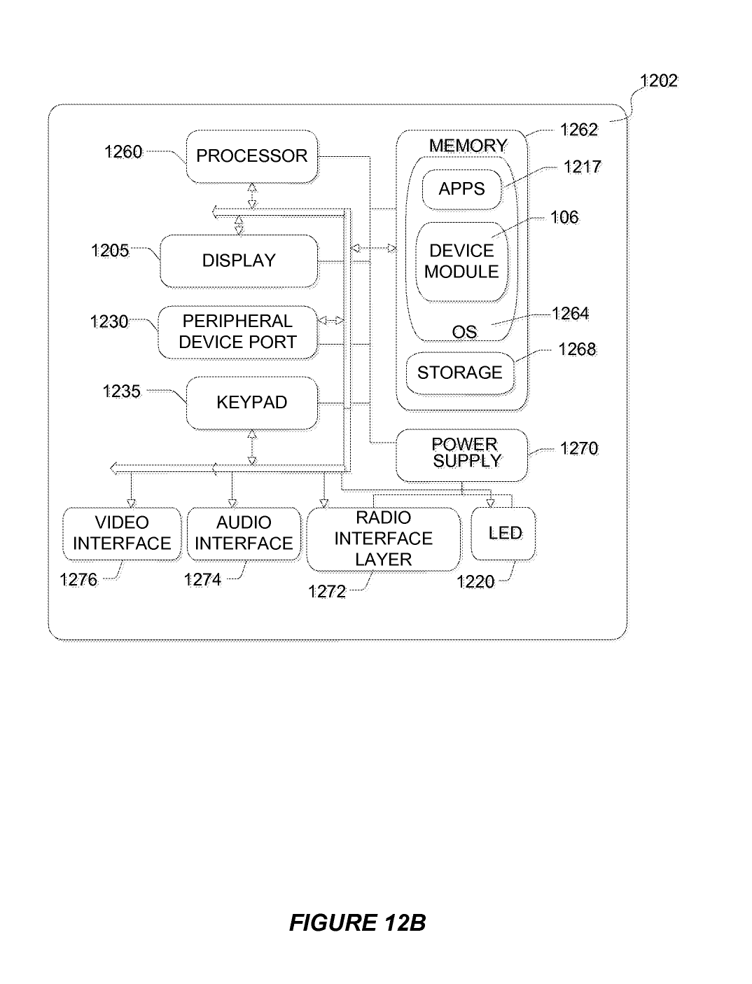

FIGS. 12A and 12B illustrate a mobile computing device 1200, for example, a mobile telephone, a smart phone, a tablet personal computer, a laptop computer, and the like, with which embodiments of the invention may be practiced. With reference to FIG. 12A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 12B is a block diagram illustrating the architecture of one embodiment of a mobile computing device. That is, the mobile computing device 1200 can incorporate a system (i.e., an architecture) 1202 to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the device module 106 described herein.

The system 1202 has a power supply 1270, which may be implemented as one or more batteries. The power supply 1270 might further include an external power source, such as an AC adapter or a powered docking cradle that supplements or recharges the batteries

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera 1230 to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 12B by the non-volatile storage area 1268.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

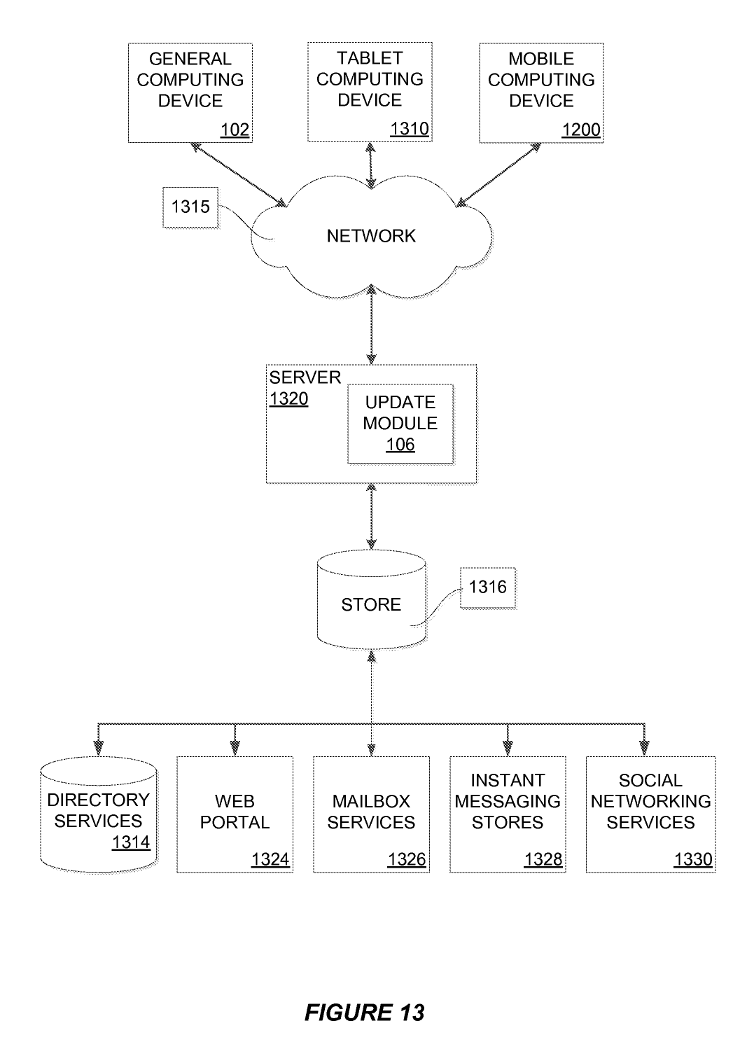

FIG. 13 illustrates one embodiment of the architecture of a system for managing device driver updates, as described above. Drivers managed with the device module 106 may be stored in different communication channels or other storage types. For example, various documents may be stored using a directory service 1322, a web portal 1324, a mailbox service 1326, an instant messaging store 1328, or a social networking site 1330. The device module 106 may use any of these types of systems or the like for enabling data utilization, as described herein. A server 1320 may provide the device module 106 to clients. As one example, the server 1320 may be a web server providing the device module 106 over the web. The server 1320 may provide the device module 106 over the web to clients through a network 1315. By way of example, the client computing device may be implemented as the computing device 102 and embodied in a personal computer, a tablet computing device 1310 and/or a mobile computing device 1200 (e.g., a smart phone). Any of these embodiments of the client computing device 102, 1310, 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A computer-implemented method for managing update dependencies comprising:
at a computing device, receiving an update set from an update service, further including receiving an indication that a first update in the update set includes a dependency on a second update in the update set;
separating the first and second updates from the update set;
installing the first and second updates; and
applying an activation condition to the first and second updates.

2. The computer-implemented method of claim 1, wherein receiving the update set is responsive to a query sent from the computing device to an update service, the query further including at least one of computing device hardware information or computing device state information.

3. The computer-implemented method of claim 1, wherein receiving the update set further comprises:
receiving at least one of set of firmware updates or a set of device driver updates.

4. The computer-implemented method of claim 3, wherein, if the set of updates is a set of device driver updates, receiving at least one update for a non-present device connectable to the computing device or a targeted device that has not previously been connected to the computing device and receiving an indication that the at least one update includes a dependency on at least one additional update in the update set.

5. The computer-implemented method of claim 1, wherein separating the first and second updates further comprises:
storing the first and second updates in a designated repository separate from a local update store.

6. The computer-implemented method of claim 1, wherein installing the first and second updates includes:
installing the first and second updates either during a background update process or an interactive foreground update process.

7. The computer-implemented method of claim 1, wherein applying an activation waiting period comprises:
configuring the first and second updates to activate upon a restart of the computing device.

8. The computer-implemented method of claim 1, further comprising:
installing remaining updates in the update set; and
configuring at least one of the remaining updates to activate on-demand when a corresponding device or utility is detected.

9. The computer-implemented method of claim 1, wherein the applying the activation condition comprises:
applying an activation waiting period to the first and second updates.

10. The computer-implemented method of claim 1, further comprising:
sending feedback regarding installation of the first and second updates to the update service using telemetry.

11. The computer-implemented method of claim 10, wherein the telemetry is configured to:
provide at least one of an update set level status reporting or an item level status reporting; and
distinguish between an update including a dependency and an update without a dependency within the update set.

12. A computer-implemented method for managing update dependencies comprising:
receiving a request for an update set from a computing device, including receiving computing device hardware and state information;
building an update set including a plurality of updates, wherein at least a first update of the plurality of updates includes a dependency indication, and wherein the dependency indication applied to the first update includes an indication that the first update is dependent on a second update; and
providing the update set to the computing device, including providing the first update, the second update, and the dependency indication for each of the plurality of updates in the update set.

13. The computer-implemented method of claim 12, wherein building the update set further comprises:
comparing the received computing device hardware and state information to stored update set information; and
building the update set based on the comparison.

14. The computer-implemented method of claim 12, further comprising:
receiving dependency information from an update publisher.

15. The computer-implemented method of claim 14, further comprising:
performing a dependency determination by evaluating one or more dependency rules to apply the received dependency indication to the updates in the update set.

16. The computer-implemented method of claim 15, further comprising:
applying a dependency indication to at least one update indicating that the at least one update does not include a dependency.

17. The computer-implemented method of claim 12, further comprising:
receiving installation status information regarding at least one update in the update set that includes a dependency via telemetry reporting.

18. A computer-readable storage medium storing instructions for managing device drivers, the instructions, when executed, causing a computing device to perform a method, the method comprising:
querying an update service for an update set, the query further including at least one of computing device hardware information or computing device state information receiving the update set from an update service, wherein at least a first update of the update set includes a dependency indication, and wherein at least the dependency indication includes an indication that the first update includes a dependency on a second update in the update set;
separating the first and second updates from the update set, further comprising
storing the first and second updates in a designated repository separate from a local update store;
installing the first and second updates; and
applying an activation waiting period to the first and second updates, wherein the activation waiting period includes at least one of waiting until a restart of the computing device or waiting until a specified activation event to activate the first and second updates.

19. The computer-readable storage medium of claim 18, further comprising:
using telemetry to report installation information to the update service.

20. The computer-readable storage medium of claim 19, wherein the telemetry is configured to:
provide at least one of a update set level status reporting or an item level status reporting; and
distinguish between an update including a dependency and an update without a dependency within the update set.
